(19) United States
(12) Patent Application Publication
(10) Pub. No.: US 2017/0208448 A1
(43) Pub. Date: Jul. 20, 2017

(54) DEVICE-TO-DEVICE (D2D) SIGNALING

(71) Applicant: FUJITSU LIMITED, Kawasaki-shi, Kanagawa (JP)

(72) Inventor: Chenxi ZHU, Fairfax (VA)

(73) Assignee: FUJITSU LIMITED, Kawasaki-shi, Kanagawa (JP)

(21) Appl. No.: 15/328,025

(22) PCT Filed: Dec. 30, 2014
(86) PCT No.: PCT/US14/72790

§ 371 Date: Jan. 21, 2017

Related U.S. Application Data
(60) Provisional application No. 62/027,089, filed on Jul. 21, 2014.

(51) Int. Cl. H04W 8/00; H04W 52/38; H04W 52/24

(52) U.S. Cl. CPC H04W 8/005; H04W 52/242; H04W 52/383

(57) ABSTRACT

A method performed by a wireless device to discover neighboring wireless devices is disclosed. The method may include receiving a first device-to-device discovery signal from a first wireless device at a second wireless device in a wireless communication network. The first device-to-device discovery signal may include a first transmission power level of the first device-to-device discovery signal. The method may also include determining, at the second wireless device and based on the first transmission power level, whether a second device-to-device discovery signal transmitted at a second transmission power level to the first wireless device by the second wireless device is received at the first wireless device with a signal power level above a decode power level threshold.

### FIELD

The present disclosure relates to device-to-device (D2D) signaling.

### BACKGROUND

The proliferation of smartphones, tablets, laptop computers, and other electronic devices (referred to generally as “wireless devices”) that use wireless communication networks has created an increased demand for ubiquitous and continuous wireless voice and data access. Being able to reuse and share wireless communication resources between wireless devices may help satisfy this demand. One way to reuse and share wireless communication resources is through wireless device-to-device (D2D) communication. D2D communication may allow wireless devices to directly communicate information between each other using lower power transmissions than if the wireless devices were to communicate with each other via an access point (e.g., a base station). The lower power transmissions may allow for increased use of the same wireless communication resources in a particular area.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method performed by a wireless device to discover neighboring wireless devices is disclosed. The method may include receiving a first device-to-device discovery signal from a first wireless device at a second wireless device in a wireless communication network. The first device-to-device discovery signal may include a first transmission power level of the first device-to-device discovery signal. The method may also include determining, at the second wireless device and based on the first transmission power level, whether a second device-to-device discovery signal transmitted at a second transmission power level to the first wireless device by the second wireless device is received at the first wireless device with a signal power level above a decode power level threshold.

The object and advantages of the embodiments will be realized and achieved at least by the elements, features, and combinations particularly pointed out in the claims.

It is to be understood that both the foregoing general description and the following detailed description are exemplary and explanatory and are not restrictive of the present disclosure, as claimed.

### BRIEF DESCRIPTION OF THE DRAWINGS

Example embodiments will be described and explained with additional specificity and detail through the use of the accompanying drawings in which:

FIG. 1 illustrates an example wireless communication network configured to perform device-to-device signaling;

FIG. 2 illustrates another example wireless communication network configured to perform device-to-device signaling;

FIG. 3 illustrates an example wireless device configured to perform device-to-device signaling;

FIG. 4 is a flow chart of an example method to discover neighboring wireless devices; and

FIG. 5 is a flow chart of another example method to discover neighboring wireless devices.

### DESCRIPTION OF EMBODIMENTS

Device-to-device (D2D) communication may provide for direct data transmission between wireless devices in a wireless communication network. In some embodiments, D2D communication may be an overlay to regular cellular communications performed through an access point, such as a base station. In these and other embodiments, the wireless devices may set a transmission power level, which may be a power level at which the wireless device transmits communication in the wireless communication network, based on communications with another device, such as an access point or wireless device in the wireless communication network. As a result, the wireless devices operating in the wireless communication network may have different transmission power levels. To allow a first wireless device to inform other wireless devices in the wireless communication network about the first wireless device's transmission power level, the transmission power level of the first wireless device may be provided in a D2D discovery signal transmitted by the first wireless device to other wireless devices.

In some embodiments, the other wireless devices may use the provided transmission power level in the received D2D discovery signal to determine if their own transmission power level is sufficient to send a D2D discovery signal back to the first wireless device to allow the first wireless device to discover the other wireless devices. Based on the determination, the other wireless devices may increase their own transmission power level or indicate to other operations executing on the other wireless devices that they may or may not be discovered by the first wireless device.

Embodiments of the present disclosure will be explained with reference to the accompanying drawings.

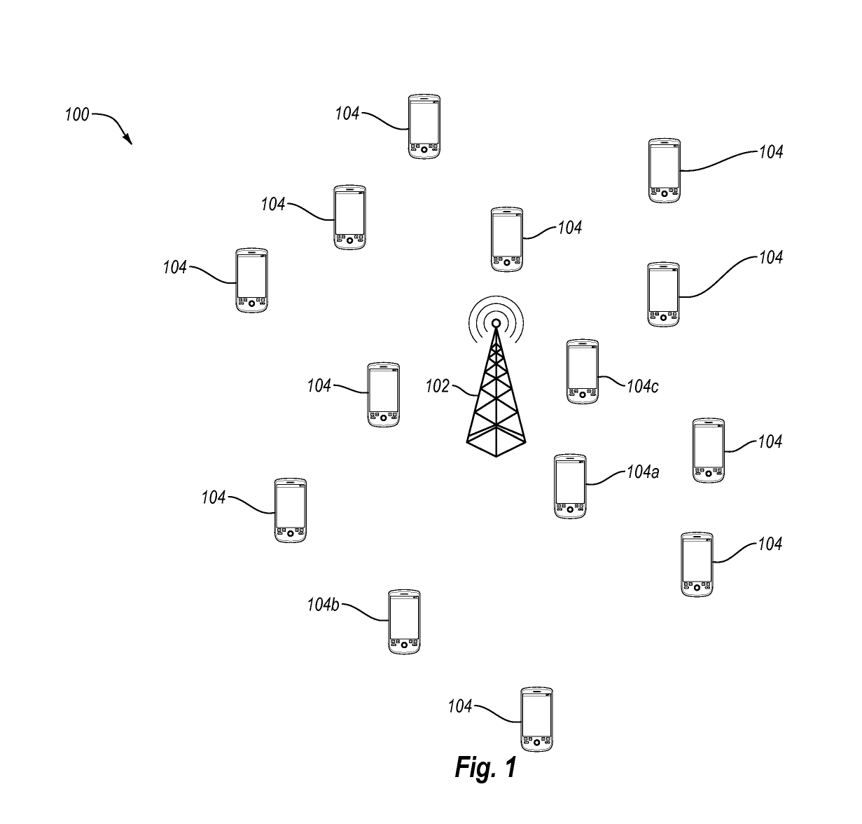

FIG. 1 illustrates an example wireless communication network 100 (referred to hereinafter as “network 100”) configured to perform D2D signaling, arranged in accordance with at least one embodiment of the present disclosure. The network 100 may be configured to provide wireless communication services to one or more wireless devices 104 via one or more access points 102. The wireless communication services may be voice services, data services, messaging services, and/or any suitable combination thereof. The network 100 may include a Frequency Division Multiple Access (FDMA) network, an Orthogonal FDMA (OFDMA) network, a Code Division Multiple Access (CDMA) network, a Time Division Multiple Access (TDMA) network, and/or any other suitable wireless communication network. In some embodiments, the network 100 may be configured as a third generation (3G) wireless communication network and/or a fourth generation (4G) wireless communication network. In these or other embodiments, the network 100 may be configured as a long-term evolution (LTE) or LTE advanced wireless communication network.

The access point 102 may be any suitable wireless communication network communication point and may include, by way of example, a base station, an evolved node “B” (eNB) base station, a remote radio head (RRH), or any other suitable communication point. The wireless devices 104 may include any devices that may use the network 100 for obtaining wireless communication services and may include, by way of example, a cellular phone, a smartphone, a personal data assistant (PDA), a laptop computer, a personal computer, and a tablet computer, or any other similar device.

At least some of the wireless devices 104 in the network 100 may be configured to perform D2D communication. To perform D2D communication within the network 100, the wireless devices 104 may first discover the wireless devices 104 within the network 100 with which the wireless devices 104 may wirelessly communicate. The wireless devices 104 with which the wireless devices 104 may communicate may be considered the neighbors of the wireless devices 104. For example, a first wireless device 104a may have a second wireless device 104b as a neighbor wireless device 104.

In general, D2D communication may increase network capacity by allowing for spatial multiplexing, which may increase the reuse and sharing of wireless communication resources. Additionally, a D2D link between wireless devices may have improved channel quality as compared to a link between a wireless device and an access point of a wireless communication system. Further, the communication of data between wireless devices through D2D communication may be direct instead of being relayed by an access point, which may reduce the usage of wireless communication resources. The direct communication may also reduce delays that may be associated with relaying data through the access point. In some instances, D2D communication may also extend the coverage of a cell associated with an access point by relaying information to and from the access point via a D2D relay.

The wireless devices 104 may discover their neighboring wireless devices 104 using various types of D2D discovery signals. For example, the first wireless device 104a may transmit a first D2D discovery signal that is received and decoded by the second wireless device 104b. In these and other embodiments, the first wireless device 104a may then be known to the second wireless device 104b. The second wireless device 104b, however, may not be known to the first wireless device 104a. In these and other embodiments, the second wireless device 104b may send a second D2D discovery signal to the first wireless device 104a. When the first wireless device 104a receives and decodes the second D2D discovery signal from the second wireless device 104b, the second wireless device 104b may be known to the first wireless device 104a. After the first wireless device 104a and the second wireless device 104b are known to each other, they may perform D2D communication.

In general, the D2D discovery signals transmitted by the wireless devices 104 may be transmitted at different transmission power levels. The transmission power levels at which the D2D discovery signals are transmitted may be based on a particular transmission power level of the wireless device 104 transmitting the D2D discovery signal. The particular transmission power level may be at a power level at which the wireless devices 104 may transmit D2D communications and other communications within the network 100.

In some embodiments, the transmission power levels of the wireless devices 104 may be based on communications between the wireless devices 104 and the access point 102. For example, the wireless devices 104 may communicate with the access point 102 to gain access to the network 100 and/or to send and receive data over the network 100. In some embodiments, the wireless devices 104 may obtain their transmission power levels by determining their transmission power levels based on the communications with the access point 102. Alternately or additionally, the access point 102 may send each of the wireless devices 104 their corresponding transmission power level for communicating in the network 100 based on the access points 102 communications with the wireless devices 104. As a result, the transmission power levels of D2D discovery signals transmitted by the wireless devices 104 may be different.

Alternately or additionally, the transmission power levels for D2D discovery signals transmitted by the wireless devices 104 may be based on communications between another of the wireless devices 104 that is managing, controlling, or otherwise overseeing the D2D communications between two of the wireless devices 104. In these and other embodiments, the transmission power levels of D2D discovery signals transmitted by the wireless devices 104 may also be different.

Alternately or additionally, the transmission power levels for D2D discovery signals transmitted by the wireless devices 104 may be set using some other criteria. Using the other criteria may also result in the transmission power levels of D2D discovery signals transmitted by the wireless devices 104 being different.

For example, the second wireless device 104b and a third wireless device 104c may communicate with the first wireless device 104a. Based on the communications, the second wireless device 104b may obtain a particular transmission power level for D2D discovery signals, referred to as a second transmission power level. The third wireless device 104c may also obtain a particular transmission power level for D2D discovery signals, referred to as a third transmission power level. In these and other embodiments, the second and third transmission power levels may be different. In particular, the third transmission power level for D2D discovery signals may be less than the second transmission power level for D2D discovery signals. Furthermore, the second wireless device 104b may be unaware of the third transmission power level of the third wireless device 104c and the third wireless device 104c may be unaware of the second transmission power level of the second wireless device 104b.

Due to the difference between the second and third transmission powers, in some embodiments, the second and the third wireless devices 104b and 104c may be unable to discover each other and perform D2D communications.

For example, D2D discovery signals transmitted between the second and the third wireless devices 104b and 104c may be transmitted in a channel between the second and the third wireless devices 104b and 104c. The channel may have a path loss. In some embodiments, the path loss may be sufficient such that D2D discovery signals sent by the third wireless device 104c may not reach the second wireless device 104b with a sufficient power level to allow the second wireless device 104b to properly decode the D2D discovery signals. However, D2D discovery signals transmitted by the second wireless device 104b may reach the third wireless device 104c with a sufficient power level to allow the third wireless device 104c to properly decode the D2D discovery signals. As a result, the third wireless device 104c may know of or discover the second wireless device 104b but the second wireless device 104b may not know of or discover the third wireless device 104c.

The circumstance when one wireless device 104 may discover another of the wireless devices 104 while the other of the wireless devices 104 may not discover the one wireless device 104 may be referred to herein as unidirectional discovery. During unidirectional discovery, the wireless devices 104 that discover other wireless devices 104 by receiving D2D discovery signals from the other wireless devices 104 but are unable to be discovered by the other wireless devices 104 because their D2D discovery signals are not received by the other wireless devices 104 may be referred to herein as undiscovered wireless devices 104. The wireless devices 104 that are discovered by the other wireless devices may be referred to herein as discovered wireless devices 104.

To help the second and third wireless devices 104b and 104c to determine whether the second and the third wireless devices 104b and 104c may be discovered by each other, the D2D discovery signals transmitted by the second and the third wireless devices 104b and 104c may include the transmission power levels of the second and the third wireless devices 104b and 104c.

For example, the second wireless device 104b may send a first D2D discovery signal to discover its neighboring wireless devices 104. The second wireless device 104b may construct the first D2D discovery signal so that the first D2D discovery signal includes the second transmission power level of the second wireless device 104b. As a result, the first D2D discovery signal includes the transmission power level at which the first D2D discovery signal is transmitted. The second wireless device 104b may transmit the first D2D discovery signal to other of the wireless devices 104, such as the third wireless device 104c.

Other of the wireless devices 104, including the third wireless device 104c, may receive the D2D discovery signal with the second transmission power level. Using the second transmission power, the other of the wireless device 104 and the third wireless device 104c may determine if D2D discovery signals that they transmit may be received by the second wireless device 104b at power levels above a decode power level threshold. The decode power level threshold may be a particular power level that allows a wireless device 104 in the network 100 to properly decode a wireless signal. The decode power level threshold may be based on the characteristics of the network 100 and/or the wireless devices 104. For example, the decode power level threshold may depend on the sensitivity of the electronics in the wireless device 104, the modulation and/or coding scheme used by the network 100, and/or error tolerance of wireless communications, among other factors.

For example, the third wireless device 104c may receive the first D2D discovery signal that includes the second transmission power. The third wireless device 104c may be configured to estimate a received power level of the first D2D discovery signal when received by the third wireless device 104c. Based on the received power level and the second transmission power level, the third wireless device 104c may estimate a path loss of a physical wireless communication channel between the second wireless device 104b and the third wireless device 104c.

The third wireless device 104c may compare the estimated path loss with the third transmission power level, at which the third wireless device 104c transmits D2D discovery signals, to determine a power level of a second D2D discovery signal at the second wireless device 104b that is transmitted by the third wireless device 104c. When the determined power level is above the decode power level threshold, the third wireless device 104c may determine that the second wireless device 104b may receive and decode the second D2D discovery signal to allow the second wireless device 104b to discover the third wireless device 104c. When the determined power level is not above the decode power level threshold, the third wireless device 104c may determine that the second wireless device 104b may not be able to decode the second D2D discovery signal received and the second wireless device 104b may thus not discover the third wireless device 104c

In some embodiments, when the determined power level is not above the decode power level threshold the third wireless device 104c may increase the third transmission power. In these and other embodiments, the third wireless device 104c may increase the third transmission power until the third wireless device 104c may determine that the second D2D discovery signal may be received at the second wireless device 104b with a power level that is above the decode power level threshold.

Alternately or additionally, the third wireless device 104c may send an indication that it will be an undiscovered wireless device with respect to the second wireless device 104b to the first wireless device 104a or the access point 102.

In some embodiments, after making the determination about the power level of a second D2D discovery signal at the second wireless device 104b, the third wireless device 104c may notify a program executed by the third wireless device 104c of the determination.

Modifications, additions, or omissions may be made to the network 100 without departing from the scope of the present disclosure. For example, in some embodiments, one of the second and third wireless devices 104b and 104c may be in communication with the access point 102 and the other of the second and third wireless devices 104b and 104c may not be communication with the access point 102.

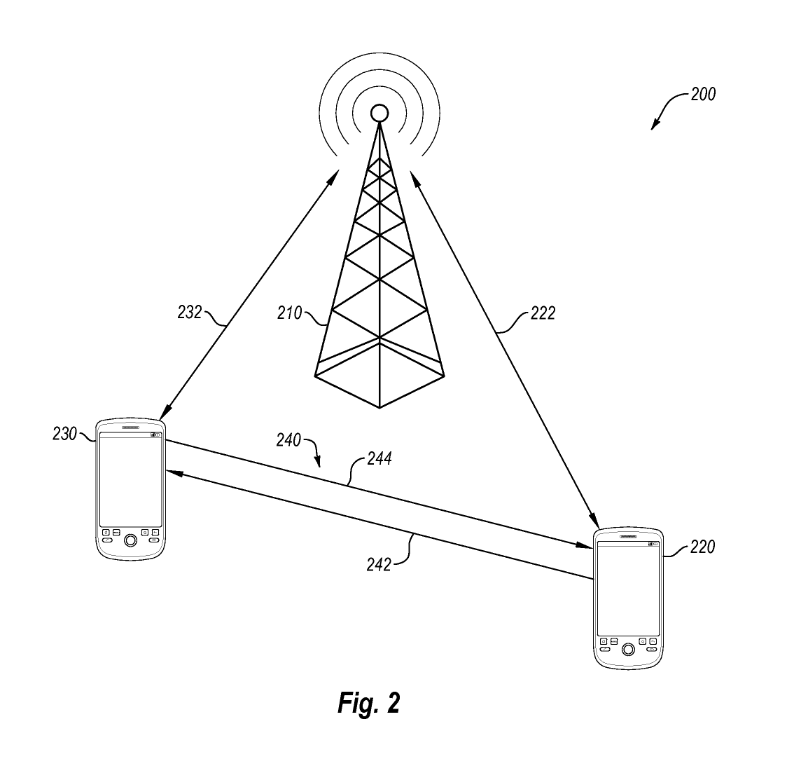

FIG. 2 illustrates an example wireless communication network 200 (referred to hereinafter as “network 200”) configured to perform D2D signaling, arranged in accordance with at least one embodiment of the present disclosure. The network 200 may be configured to provide wireless communication services to the first wireless device 220 and the second wireless device 230 via the access point 210. In these and other embodiments, the network 200 may be analogous to the network 100 of FIG. 1 and the access point 210 may be analogous to the access point 102 of FIG. 1.

The first wireless device 220 and the second wireless device 230 may include any device that may use the network 200 for obtaining wireless communication services and may include, by way of example, a cellular phone, a smartphone, a personal data assistant (PDA), a laptop computer, a personal computer, and a tablet computer, or any other similar device.

The first wireless device 220 and the second wireless device 230 in the network 200 may be configured to perform D2D communication. To perform D2D communication within the network 200, the first wireless device 220 and the second wireless device 230 may first discover each other. After the first wireless device 220 and the second wireless device 230 discover each other, they may be considered the neighboring wireless devices. The terms “neighbor” and “neighboring” wireless devices may refer to wireless devices that may be in the same general vicinity with respect to each other. The terms are not limited to wireless devices being directly adjacent to each other, or the wireless device or wireless devices closest to a particular wireless device.

In some embodiments, the network 200 may be configured to supervise D2D communication between the first wireless device 220 and the second wireless device 230. In some of these embodiments, the access point 210 may be configured to direct the discovery between the first wireless device 220 and the second wireless device 230 such that the first wireless device 220 and the second wireless device 230 may be coupled together as a D2D pair performing D2D communication.

The access point 210 may be configured to instruct the first wireless device 220 and the second wireless device 230 to participate in neighbor discovery when the first wireless device 220 and the second wireless device 230 indicate that they are capable and willing to participate in D2D communication. For example, the access point 210 may be configured to perform radio resource control (RRC) signaling in which the access point 210 may instruct the first wireless device 220 and the second wireless device 230 to transmit a D2D discovery signal. Additionally or alternately, the access point 210 may instruct the first wireless device 220 and the second wireless device 230 to listen for a D2D discovery signal.

In general, D2D discovery signals transmitted by the first wireless device 220 and the second wireless device 230 may be transmitted at different transmission power levels. The transmission power levels at which the D2D discovery signals are transmitted may be based on a particular transmission power level of the wireless device transmitting the D2D discovery signals. The particular transmission power level may be at a power level at which the wireless devices may transmit D2D communications within the network 200.

In some embodiments, the transmission power levels of the first wireless device 220 and the second wireless device 230 may be based on communications between the first wireless device 220 and the second wireless device 230 and the access point 210. As an example, the access point 210 may determine a first transmission power level of the first wireless device 220 based on one or more of the following expressions based on communications with the access point 210:

P_{NDS}=min(Pₘₐₓ, α·PL_{C}+LP_{C}+ΔP_{WD});

P_{NDS}=min(Pₘₐₓ, α·P_{SRS}+ΔP_{C}+ΔP_{WD});

P_{NDS}=min(Pₘₐₓ, α·P_{PUSCH}+ΔP_{c}+ΔP_{WD}); and

P_{NDS}=min(Pₘₐₓ, α·PL_{PUCCH}+ΔP_{C}+ΔP_{WD})

In the above expressions: “P_{NDS}” may represent the first transmission power level of the first wireless device 220; “Pₘₐₓ” may represent the maximum transmission power of the first wireless device 220; “α” may represent the weighting factor associated with the interference experienced by uplink communications in the network 200; “PL_{C}” may represent the path loss between the first wireless device 220 and the access point 210 along a first communication path 222; “P_{SRS}” may represent the SRS signal power of an SRS signal transmitted between the first wireless device 220 and the access point 210; “P_{PUSCH}” may represent the PUSCH signal power of a PUSCH signal transmitted between the first wireless device 220 and the access point 210; “P_{PUCCH}” may represent the PUCCH signal power of a PUCCH signal transmitted between the first wireless device 220 and the access point 210; “ΔP_{C}” may represent a cell specific power control adjustment that is based on a configuration of the network 200 and a number of wireless devices serviced by the access point 210 that may be classified as neighboring wireless devices; and “ΔP_{WD}” may represent an individual power control adjustment associated with the first wireless device 220 that is based on a number of discovered neighboring wireless devices of the first wireless device 220.

In some embodiments, the above expressions may be used by the access point 210 to determine a first transmission power level of D2D discovery signals transmitted by the first wireless device 220. In particular, the above expressions may be used by the access point 210 to determine a first transmission power level of D2D discovery signals transmitted by the first wireless device 220 over one or more frequencies associated with uplink communications.

When the first wireless device 220 is configured to transmit the D2D discovery signals over one or more frequencies associated with downlink communications, the access point 210 may determine the first transmission power level in a different manner. In these and other embodiments, the access point 210 may determine the first transmission power level based on the following expression:

P_{NDS}=min(Pₘₐₓ, P_{C}+ΔP_{WD})

In the above expression: “P_{NDS}” may represent the determined first transmission power level of the first wireless device 220; “Pₘₐₓ” may represent the maximum transmission power of the first wireless device 220; “P_{C}” may represent a cell specific power level that is based on a configuration of the network 200 and a number of wireless devices serviced by the access point 210 that may be classified as neighboring wireless devices; and “ΔP_{WD}” may represent an individual power control adjustment based on a number of discovered neighboring wireless devices of first wireless device 220. After determining the first transmission power level, the access point 210 may send the first transmission power level to the first wireless device 220.

In some embodiments, the access point 210 may determine a second transmission power level of the second wireless device 230 in a similar manner. For example, the access point 210 may determine the second transmission power level based on a path loss between the second wireless device 230 and the access point 210 along a second communication path 232. The access point 210 may send the second transmission power level to the second wireless device 230.

When performing neighbor discovery, the first wireless device 220 may construct a first D2D discovery signal 242. The first wireless device 220 may construct the first D2D discovery signal 242 so that the first D2D discovery signal 242 includes the first transmission power level. In some embodiments, the first transmission power level may be included in the first D2D discovery signal 242 by including a code or some data that represents the first transmission power level or an approximate value equal to the first transmission power level. In some embodiments, the first D2D discovery signal 242 may include the first transmission power level in a preamble, in a data section, or in some other portion of the first D2D discovery signal 242. After constructing the first D2D discovery signal 242, the first wireless device 220 may send the first D2D discovery signal 242 along a channel 240 between the first wireless device 220 and the second wireless device 230.

The channel 240 may represent a physical path between the first wireless device 220 and the second wireless device 230. The channel 240 may have a path loss. Transmitting the first D2D discovery signal 242 over the channel 240 may reduce the power level of the first D2D discovery signal 242 by the path loss. For example, assume that the first transmission power level is 1TPL and the first D2D discovery signal 242 is transmitted at the 1TPL and the path loss is PL. As a result, the power level of the first D2D discovery signal 242 when received at the second wireless device 230 may be a difference between the first transmission power level and the path loss, e.g, 1TPL−PL.

The second wireless device 230 may receive the first D2D discovery signal 242. If the power level of the first D2D discovery signal 242 when received at the second wireless device 230 is greater than a decode power level threshold the second wireless device 230 may decode the first D2D discovery signal 242. When the second wireless device 230 decodes the first D2D discovery signal 242, the second wireless device 230 may discover the first wireless device 220.

When the second wireless device 230 receives the first D2D discovery signal 242, the second wireless device 230 may also estimate a power level of the first D2D discovery signal 242 when it is received at the second wireless device 230. Based on the estimated power level and the first transmission power level, the second wireless device 230 may estimate a path loss PL of the channel 240. For example, assume that the first transmission power level is 1TPL and the power level of the first D2D discovery signal 242 is DPL when received at the second wireless device 230. The path loss PL may be determined based on the difference between the first transmission power level and the power level of the first D2D discovery signal 242 when received at the second wireless device 230, e.g, PL=1TPL−DPL.

Based on the determined path loss, the second wireless device 230 may determine if a second D2D discovery signal 244 transmitted by the second wireless device 230 along the channel 240 may be received at the first wireless device 220 with a power level above the decode power level threshold. For example, assume that the second transmission power level is 2TPL and the decode power level threshold is DPL. When 2TPL−PL>=DPL, the second D2D discovery signal 244 may be received and properly decoded by the first wireless device 220. In these and other embodiments, the second wireless device 230 may be discovered by the first wireless device 220.

When 2TPL−PL<DPL, the second D2D discovery signal 244 may not be properly decoded by the first wireless device 220 after being received by the first wireless device 220. As a result, the second wireless device 230 may determine that it may not be discovered by the first wireless device 220. In these and other embodiments, the second wireless device 230 may increase the second transmission power level until 2TPL−PL>=DPL such that the second wireless device 230 may be discovered by the first wireless device 220. After the first and second wireless devices 220 and 230 discover each other, the first and second wireless devices 220 and 230 may participate in D2D communication.

Modifications, additions, or omissions may be made to the network 200 without departing from the scope of the present disclosure.

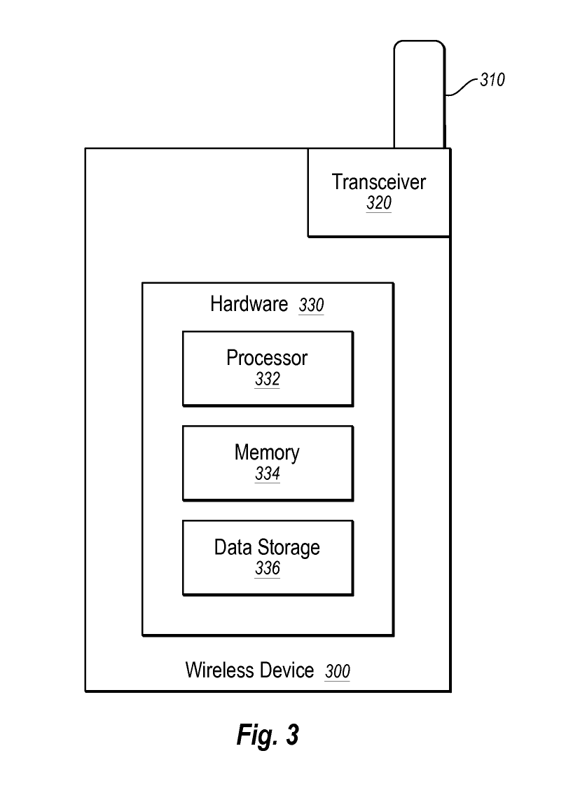

FIG. 3 illustrates an example wireless device 300 configured to perform device-to-device signaling, arranged in accordance with at least one embodiment of the present disclosure. The wireless device 300 may be an example of one of the wireless devices 104 of FIG. 1, the first or second wireless devices 220 and 230 of FIG. 2, or some other wireless device configured to operate in a wireless communication network.

The wireless device 300 may include an antenna 310, a transceiver 320, and hardware 330. Generally, the hardware may include an application-specific integrated circuit (ASIC), a Field-Programmable Gate Array (FPGA), or any other digital or analog circuitry configured to perform operations, such as the operations described as performed by the wireless devices 104 of FIG. 1 or the first or second wireless devices 220 and 230 of FIG. 2. As illustrated in FIG. 3, the hardware 330 may include a processor 332, a memory 334, and data storage 336. In these and other embodiments, the processor 332, the memory 334, and the data storage 336 may be configured to perform some or all of the operations performed by the hardware 330. In other embodiments, the hardware 330 may not include one or more of the processor 332, the memory 334, and the data storage 336.

Generally, the processor 332 may include any suitable special-purpose or general-purpose computer, computing entity, or processing device including various computer hardware or software modules and may be configured to execute instructions stored on any applicable computer-readable storage media. For example, the processor 332 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, it is understood that the processor 332 may include any number of processors configured to perform individually or collectively any number of operations described herein. Additionally, one or more of the processors may be present on one or more different electronic devices. In some embodiments, the processor 332 may interpret and/or execute program instructions and/or process data stored in the memory 334, the data storage 336, or the memory 334 and the data storage 336. In some embodiments, the processor 332 may fetch program instructions from the data storage 336 and load the program instructions in the memory 334. After the program instructions are loaded into the memory 334, the processor 332 may execute the program instructions.

The memory 334 and data storage 336 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 332. By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 332 to perform a certain operation or group of operations.

The antenna 310 may be coupled to the transceiver 320. The antenna 310 may have any number of configurations. The antenna 310 may also be configured to transmit and receive wireless communication signals in a wireless communication network. In particular, the antenna 310 may be configured to transmit wireless communications between the wireless device 300 and an access point and receive D2D discovery signals. In these and other embodiments, the D2D discovery signal may include a transmission power level of the D2D discovery signal when transmitted by another device. The antenna 310 may send the received wireless communication signals to the transceiver 320.

The antenna 310 may be further configured to receive wireless communication signals for transmission from the transceiver 320. The antenna 310 may transmit the wireless communication signals to other devices in the wireless communication network in which the wireless device 300 is operating.

The transceiver 320 may be coupled to the antenna and the hardware 330. The transceiver 320 may be configured to estimate a received power level of the wireless communication signals received by the antenna 310. The transceiver 320 may provide the wireless communication signal and the estimate of the received power level to the hardware 330.

The transceiver 320 may be further configured to receive a transmission power level from the hardware 330. The transmission power level may be a power level that the transceiver 320 may apply to wireless communications that are sent to the antenna 310 to be transmitted by the wireless device 300. For example, the hardware 330 may provide a D2D discovery signal to the transceiver. The transceiver 320 may apply the transmission power level to the D2D discovery signal using an amplifier circuit, amplifier chain circuit, or some other circuit. The transceiver 320 may end the D2D discovery signal at the transmission power level to the antenna 310 for transmission by the antenna 310 into the wireless communication network that includes the wireless device 300.

The hardware 330 may be configured to perform operations based on the wireless communication signals and the estimated received power level for the wireless communication signals from the transceiver 320. For example, in some embodiments, the hardware 330 may be configured to receive wireless communication signals from the transceiver 320 and to decode the wireless communication signals to extract data from the wireless communications signals. In some embodiments, the wireless communication signal may be a D2D discovery signal. The hardware 330 may also extract information about a neighboring wireless device that transmitted the D2D discovery signal. By extracting information about the neighboring wireless device, the wireless device 300 may discover its neighboring wireless device.

In some embodiments, the hardware 330 may extract a first transmission power level at which the D2D discovery signal is transmitted from the D2D discovery signal. The hardware 330 may also be configured to perform operations with the extracted first transmission power level and the received power level of the D2D discovery signal. For example, in some embodiments, the hardware 330 may be configured to estimate a path loss of a physical wireless communication channel between the wireless device 300 and the neighboring wireless device in the wireless communication network based on the received power level and the extracted first transmission power level.

The hardware 330 may be configured to perform other operations that are described herein as performed by wireless devices. For example, the hardware 330 may be configured to obtain a second transmission power level for transmission by the wireless device 300 based on communications between the wireless device 300 and another device, such as an access point or neighboring wireless device. In these and other embodiments, the second transmission power level may be different than the first transmission power level of wireless communications received by the wireless device 300.

Alternately or additionally, the hardware 330 may be configured to determine whether the neighboring wireless device may discover the wireless device 300 if the wireless device 300 transmits a second D2D discovery signal at the second transmission power level. The hardware 330 may determine whether the neighboring wireless device may discover the wireless device 300 based on whether the second device-to-device discovery signal that is transmitted at the second transmission power level to the neighboring wireless device is received at the neighboring wireless device with a signal power level above a decode power level threshold. In these and other embodiments, the hardware 330 may be configured to increase the second transmission power level when it is determined that the neighboring wireless device may not discover the wireless device 300.

In these and other embodiments, the hardware 330 may also be configured to notify a program executed by the wireless device 300 of the determination of whether the neighboring wireless device may discover the wireless device 300.

Modifications, additions, or omissions may be made to the wireless device 300 without departing from the scope of the present disclosure.

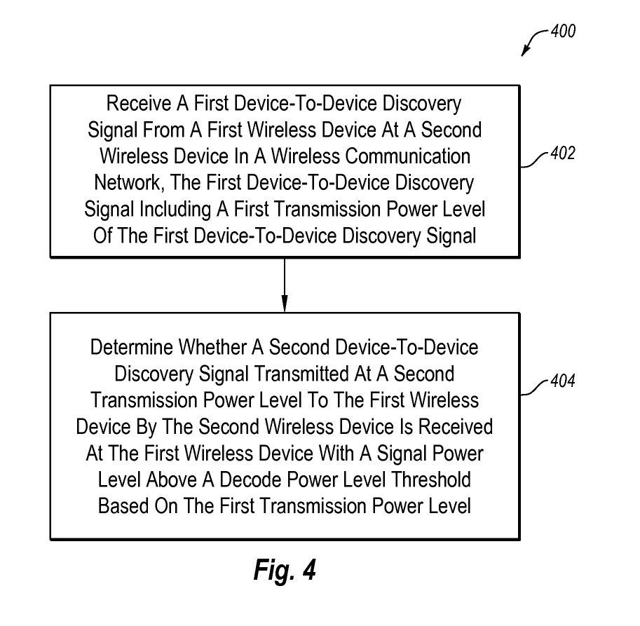

FIG. 4 is a flow chart of an example method 400 to discover neighboring wireless devices, which may be arranged in accordance with at least one embodiment described herein. The method 400 may be implemented, in some embodiments, by a wireless device, such as the wireless device 104, 220, 230, or 300 of FIGS. 1, 2, and 3, respectively. Although illustrated as discrete blocks, various blocks may be divided into additional blocks, combined into fewer blocks, or eliminated, depending on the desired implementation.

The method 400 may begin at block 402, wherein a first device-to-device discovery signal may be received from a first wireless device at a second wireless device in a wireless communication network. The first device-to-device discovery signal may include a first transmission power level of the first device-to-device discovery signal.

In block 404, it may be determined, based on the first transmission power level, whether a second device-to-device discovery signal transmitted at a second transmission power level to the first wireless device by the second wireless device is received at the first wireless device with a signal power level above a decode power level threshold.

In some embodiments, the first transmission power level may be obtained by the first wireless device based on communications between the first wireless device and another device in the wireless communication network. In some embodiments, the second transmission power level for the second wireless device may be based on communications between the second wireless device and the other device. In these and other embodiments, the other device may include an access point, such as a base station, or a third wireless device in the wireless communication network. In some embodiments, the second transmission power level may be different than the first transmission power level.

In some embodiments, determining whether the second device-to-device discovery signal transmitted at the second transmission power level to the first wireless device by the second wireless device is received at the first wireless device with a signal power level above the decode power level threshold may include various steps, operations, etc. These steps may include estimating a received power level of the first device-to-device discovery signal at the second wireless device. The steps may also include estimating a path loss of a physical wireless communication channel between the first wireless device and the second wireless device based on the received power level and the first transmission power level. The steps may also include comparing the estimated path loss between the first wireless device and the second wireless device with the second transmission power level.

In these and other embodiments, the determination of whether the second device-to-device discovery signal transmitted at the second transmission power level to the first wireless device by the second wireless device is received at the first wireless device with the signal power level above the decode power level threshold may be based on the comparison between the estimated path loss and the second transmission power level.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For instance, the method 400 may further include increasing the second transmission power level when it is determined that the second device-to-device discovery signal is not received at the first wireless device with the signal power level above the decode power level threshold. Alternately or additionally, the method 400 may further include notifying a program executed by the second wireless device of the determination of whether the second device-to-device discovery signal transmitted at the second transmission power level is received at the first wireless device with the signal power level above the decode power level threshold.

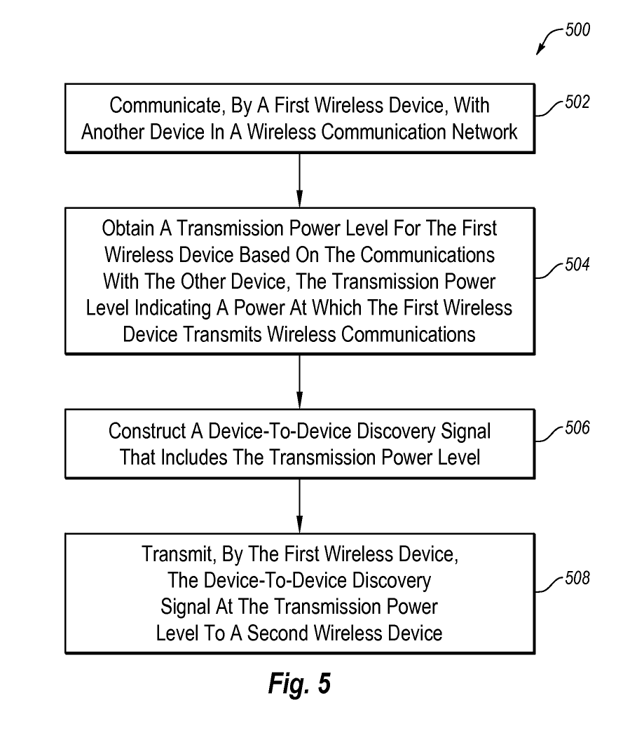

FIG. 5 is a flow chart of another example method 500 to discover neighboring wireless devices, which may be arranged in accordance with at least one embodiment described herein. The method 500 may be implemented, in some embodiments, by a wireless device, such as the wireless device 104, 220, 230, or 300 of FIGS. 1, 2, and 3, respectively. Although illustrated as discrete blocks, various blocks may be divided into additional blocks, combined into fewer blocks, or eliminated, depending on the desired implementation.

The method 500 may begin at block 502, where a first wireless device may communicate with another device in a wireless communication network.

In block 504, a transmission power level for the first wireless device may be obtained based on the communications with the other device. In some embodiments, the transmission power level may indicate a power at which the first wireless device transmits wireless communications. In some embodiments, obtaining the transmission power level may include determining, by the first wireless device, the transmission power level based on the communications with the other device or receiving the transmission power level from the other device.

In some embodiments, the other device may include an access point, such as a base station, or a third wireless device, or some other device in the wireless communication network.

In block 506, a device-to-device discovery signal may be constructed that includes the transmission power level.

In block 508, the device-to-device discovery signal may be transmitted by the first wireless device at the transmission power level to a second wireless device. In some embodiments, the second wireless device may include a second transmission power level based on communications between the second wireless device and the other device. In these and other embodiments, the second transmission power level may be different than the transmission power level.

In some embodiments, the method 500 may further include receiving, by the first wireless device, a second device-to-device discovery signal from the second wireless device. In these and other embodiments, the second device-to-device discovery signal may include a second transmission power level at which the second device-to-device discovery signal is transmitted. Furthermore, the second transmission power level may be different than the transmission power level.

As indicated above, some embodiments described herein may include the use of a special purpose or general purpose computer (e.g., the processor 332 of FIG. 3) including various computer hardware or software modules, as discussed in greater detail below. Further, as indicated above, embodiments described herein may be implemented using computer-readable media (e.g., the memory 334 of FIG. 3) for carrying or having computer-executable instructions or data structures stored thereon.

As used herein, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method, performed by a wireless device, to discover neighboring wireless devices, the method comprising:
receiving a first device-to-device discovery signal from a first wireless device at a second wireless device in a wireless communication network, the first device-to-device discovery signal including a first transmission power level of the first device-to-device discovery signal; and
determining, at the second wireless device and based on the first transmission power level, whether a second device-to-device discovery signal transmitted at a second transmission power level to the first wireless device by the second wireless device is received at the first wireless device with a signal power level above a decode power level threshold.

2. The method of claim 1, wherein the first transmission power level is obtained by the first wireless device based on communications between the first wireless device and another device in the wireless communication network.

3. The method of claim 2, wherein the second transmission power level for the second wireless device is based on communications between the second wireless device and the other device and the second transmission power level is different than the first transmission power level.

4. The method of claim 2, wherein the other device includes an access point or a third wireless device in the wireless communication network.

5. The method of claim 1, wherein the determining includes:
estimating a received power level of the first device-to-device discovery signal at the second wireless device;
estimating a path loss of a physical wireless communication channel between the first wireless device and the second wireless device based on the received power level and the first transmission power level; and
comparing the estimated path loss between the first wireless device and the second wireless device with the second transmission power level.

6. The method of claim 1, further comprising increasing the second transmission power level when it is determined that the second device-to-device discovery signal is not received at the first wireless device with the signal power level above the decode power level threshold.

7. The method of claim 1, further comprising notifying a program executed by the second wireless device of the determination of whether the second device-to-device discovery signal transmitted at the second transmission power level is received at the first wireless device with the signal power level above the decode power level threshold.

8. The method of claim 1, wherein operations to execute the method are performed by hardware in the second wireless device.

9. A method, performed by a wireless device, to discover neighboring wireless devices, the method comprising:
communicating, by a first wireless device, with another device in a wireless communication network;
obtaining a transmission power level for the first wireless device based on the communications with the other device, the transmission power level indicating a power at which the first wireless device transmits wireless communications;
constructing a device-to-device discovery signal that includes the transmission power level; and
transmitting, by the first wireless device, the device-to-device discovery signal at the transmission power level to a second wireless device.

10. The method of claim 9, wherein obtaining the transmission power level includes determining, by the first wireless device, the transmission power level based on the communications with the other device or receiving the transmission power level from the other device.

11. The method of claim 9, wherein the transmission power level is a first transmission power level, wherein the second wireless device includes a second transmission power level based on communications between the second wireless device and the other device, the second transmission power level being different than the first transmission power level.

12. The method of claim 9, wherein the other device includes an access point or a third wireless device in the wireless communication network.

13. The method of claim 9, wherein the device-to-device discovery signal is a first device-to-device discovery signal and the transmission power level is a first transmission power level, the method further comprising receiving, by the first wireless device, a second device-to-device discovery signal from the second wireless device.

14. The method of claim 13, wherein the second device-to-device discovery signal includes a second transmission power level at which the second device-to-device discovery signal is transmitted, the second transmission power level being different than the first transmission power level.

15. The method of claim 9, wherein operations to execute the method are performed by hardware in the first wireless device.

16. A wireless device, comprising:
an antenna configured to receive a device-to-device discovery signal from another device in a wireless communication network, the device-to-device discovery signal including a transmission power level of the device-to-device discovery signal;
a transceiver coupled to the antenna, the transceiver configured to estimate a received power level of the device-to-device discovery signal when received by the antenna;
hardware coupled to the transceiver, the hardware including a configuration that causes the wireless device to perform operations, the operations including:
estimating a path loss of a physical wireless communication channel between the wireless device and the other device based on the received power level and the transmission power level.

17. The wireless device of claim 16, wherein the transmission power level is a first transmission power level, the antenna is configured to receive communications from another device in the wireless communication network, and the operations further include obtaining a second transmission power level for transmission by the wireless device based on communications between the wireless device and the other device, wherein the second transmission power level is different than the first transmission power level.

18. The wireless device of claim 16, wherein the transmission power level is a first transmission power level and the device-to-device discovery signal is a first device-to-device discovery signal, wherein the operations further include determining whether a second device-to-device discovery signal transmitted at a second transmission power level to the other device by the wireless device is received at the other device with a signal power level above a decode power level threshold.

19. The wireless device of claim 18, wherein the operations further include increasing the second transmission power level when it is determined that the second device-to-device discovery signal is not received at the other device with the signal power level above the decode power level threshold.

20. The wireless device of claim 18, wherein the operations further include notifying a program executed by the wireless device of the determination of whether the second device-to-device discovery signal transmitted at the second transmission power level is received at the other device with the signal power level above the decode power level threshold.
